(19) United States
(12) Patent Application Publication
(10) Pub. No.: US 2025/0139678 A1
(43) Pub. Date: May 1, 2025

(54) SYSTEMS AND METHODS FOR RECORDATION OF INTERACTION DATA

(71) Applicant: Capital One Services, LLC, McLean, VA (US)

(72) Inventors: Shabnam KOUSHA, Washington, DC (US); Claire M. ROWLETT, Washington, DC (US); Leeyat Bracha TESSLER, Arlington, VA (US); Alexander CHASE, Brooklyn, NY (US); Daniel E. MILLER, Brooklyn, NY (US); Dennis DOUGHTY, Brookline, MA (US)

(73) Assignee: Capital One Services, LLC, McLean, VA (US)

(21) Appl. No.: 18/498,441

(22) Filed: Oct. 31, 2023

(51) Int. Cl. G06Q 30/0601; G06F 9/451

(52) U.S. Cl. CPC G06Q 30/0613; G06F 9/451

(57) ABSTRACT

A computer-implemented method for recordation of interaction data is disclosed. The method may include causing, via a remote device, a first electronic application operating on a user device to: monitor activity of a second electronic application operating on the user device; detect, based on the monitoring, an interaction between a user of the user device and an entity via the second electronic application; extract interaction data associated with the detected interaction from the second electronic application; and transmit the extracted interaction data to the remote device. The method may further include receiving, via the remote device, interaction processing data; determining, by the remote device, whether the received interaction processing data corresponds to the detected interaction; and in response to determining a correspondence between the detected interaction and the interaction processing data, storing, by the remote device, the extracted interaction data and the interaction processing data in a data storage.

### TECHNICAL FIELD

Various embodiments of this disclosure relate generally to techniques for recordation of interaction data, and, more particularly, to systems, methods, and computer readable media for automatically detecting, analyzing, and recording interaction data associated with purchases made on behalf of a business, organization, or the like.

### BACKGROUND

Organizations, such as companies, often need to track and record purchases made by the personnel, e.g., as business expenses, for accounting and security purposes. For example, a company (or business) may review and log a purchase made online by one of the company's employees as a business expense to manage the company's budget and cash flow, and to ensure that the purchase is not fraudulent. Often times, an employee of a company may use a corporate credit card (e.g., a credit card issued to the employee by the company) or a personal credit card to make a purchase online (e.g., for office supplies or travel arrangements) on behalf of the company. The employee may subsequently send a receipt for the purchase to the company's accounting team (or finance team) via email or other electronic means. The company's accounting team may then receive, review and categorize (e.g., code) the purchase, and record the categorized purchase in a ledger. However, the foregoing process for tracking the receipt and using the receipt to analyze and record the purchase, may suffer from a number of deficiencies.

For example, when the employee conducts the purchase at a website where a receipt for the purchase is only available for download immediately after completion of the purchase, the employee may forget to download the receipt. Consequently, the employee may have to contact a representative of the website to request the receipt, which would delay the employee from providing the receipt to the company's accounting team. As another example, where the employee makes a purchase at a website and subsequently receives an email that includes a receipt for the purchase in the employee's inbox, the employee may later struggle to find the email in their inbox, especially if the inbox includes multiple emails that include receipts for prior purchases the employee made at the website. Further, even if the employee has a receipt for the purchase on hand, the employee may forget to provide the receipt to the company's accounting team. As a result, the employee may not be reimbursed for the purchase and/or the company's accounting team may not be able to properly categorize or record the purchase in the company's ledger.

As another example, the employee may inadvertently submit the wrong receipt (e.g., a receipt for a different purchase) to the company's accounting team. As a result, the employee and the accounting team may have to communicate with one another to identify the error, and the employee may have to submit the correct receipt to the accounting team. Moreover, even if the employee submits the correct receipt, the receipt may not include all the information that the accounting team needs to properly categorize the purchase. For example, the receipt may not include an itemized list of the products and/or services included in the purchase, and thus the accounting team may have to contact the employee to obtain the missing information. Accordingly, improvements to the process for obtaining and verifying receipts for purchases made online by an employee of a company on behalf of the company (e.g., as business expenses) may be beneficial.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods, systems and computer readable media are disclosed for recordation of interaction data. Each of the examples disclosed herein may include one or more features described in connection with any of the other disclosed examples.

In one aspect, an exemplary embodiment of a computer-implemented method for recordation of interaction data may include causing, via a remote device, a first electronic application operating on a user device to: monitor activity of a second electronic application operating on the user device and separate from the first electronic application; detect, based on the monitoring, an interaction between a user of the user device and an entity via the second electronic application; extract interaction data associated with the detected interaction from the second electronic application; and transmit the extracted interaction data to the remote device. The computer-implemented method may further include receiving, via the remote device, interaction processing data associated with the entity; determining, by the remote device, whether the received interaction processing data corresponds to the detected interaction based on a comparison of the interaction processing data with the extracted interaction data of the detected interaction; and in response to determining a correspondence between the detected interaction and the interaction processing data, storing, by the remote device, the extracted interaction data and the interaction processing data in a data storage associated with the user.

In another aspect, an exemplary embodiment of a computer-implemented method for recordation of interaction data may include causing a first electronic application operating on a user device to: monitor activity of a second electronic application operating on the user device and separate from the first electronic application; detect, based on the monitoring, an interaction between a user of the user device and an entity via the second electronic application; extract interaction data associated with the detected interaction from the second electronic application; and transmit the extracted interaction data to a device remote from the user device.

In a further aspect, an exemplary embodiment of a non-transitory computer-readable medium may include instructions for recordation of interaction data. The instructions may be executable by at least one processor of a remote device to perform operations, including: causing a first electronic application operating on a user device to: monitor activity of a second electronic application operating on the user device and separate from the first electronic application; detect, based on the monitoring, an interaction between a user of the user device and an entity via the second electronic application; extract interaction data associated with the detected interaction from the second electronic application; and transmit the extracted interaction data to the remote device. Further, the instructions may be executable by the at least one processor of the remote device to perform operations, including: receiving interaction processing data associated with the entity; determining whether the received interaction processing data corresponds to the detected interaction based on a comparison of the interaction processing data with the extracted interaction data of the detected interaction; and in response to determining a correspondence between the detected interaction and the interaction processing data, storing the extracted interaction data and the interaction processing data in a data storage associated with the user.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for recordation of interaction data, according to one or more embodiments.

FIG. 2A depicts an example user interface for recordation of interaction data, according to one or more embodiments.

FIG. 2B depicts another example user interface for recordation of interaction data, according to one or more embodiments.

FIG. 2C depicts a further example user interface for recordation of interaction data, according to one or more embodiments.

FIG. 3 depicts a flowchart of an exemplary method for recordation of interaction data, according to one or more embodiments.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “employee” or “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software. As used herein, term “ledger” may refer to a written or recorded collection or summary (e.g., electronic or paper) of a financial account for recording and totaling economic transactions that are measured in a monetary unit.

In the following description, embodiments will be described with reference to the accompanying drawings. As will be discussed in more detail below, various embodiments, methods, systems, and computer readable media for recordation of interaction data are described.

In an exemplary use case, a user who is an employee of (or contractor for) a company, may use a user device (e.g., a laptop, a mobile phone, etc.) to shop online for one or more items, such as a printer, to purchase on behalf of the company. More specifically, the user may use a browser presented on a display screen of the user device to shop at a website at which printers are sold. While at the website, the user may interact with the website by, for example, viewing text or images on the website, moving the user's cursor over the website, and/or selecting links, buttons, and/or other elements associated with the website, to search for a printer to purchase. As the user interacts with the website, a server associated with the user's company (or employer) may cause a browser extension associated with the browser to detect the user's interactions with the website, extract data associated with the interactions, and transmit the extracted data to the server. For example, when the user selects a printer for purchase on the website, completes the purchase using the user's corporate credit card, and views a receipt for the purchase subsequently displayed on the website, the server may cause the browser extension to detect and scrape data regarding one or more of the user's interactions with the website, and to transmit the scraped data to the server. Once the server receives the scraped data, the server may analyze the scraped data to verify the purchase, e.g., by comparing the scraped data with credit card transaction data received from the issuer of the corporate credit card. An accounting team of the user's company may then retrieve, categorize (or code) the verified purchase and record the categorized purchase in the company's ledger.

As described above, existing techniques for transferring receipts for purchases made online (e.g., as business expenses) by employees of a company, to the company's accounting team, can be inefficient and result in errors in the company's ledger. However, aspects of the present disclosure provide automated and/or streamlined processes for transferring such receipts from the employees to the company's accounting team. Moreover, the techniques described herein enable a company's employees and accounting team to work more efficiently, and help to ensure that the company's ledger is accurate, complete, and updated in a timely manner.

While the example above involves a server, it should be understood that techniques according to this disclosure may be adapted to any suitable type of electronic device. It should also be understood that the example above is illustrative only. The techniques and technologies of this disclosure may be adapted to any suitable activity.

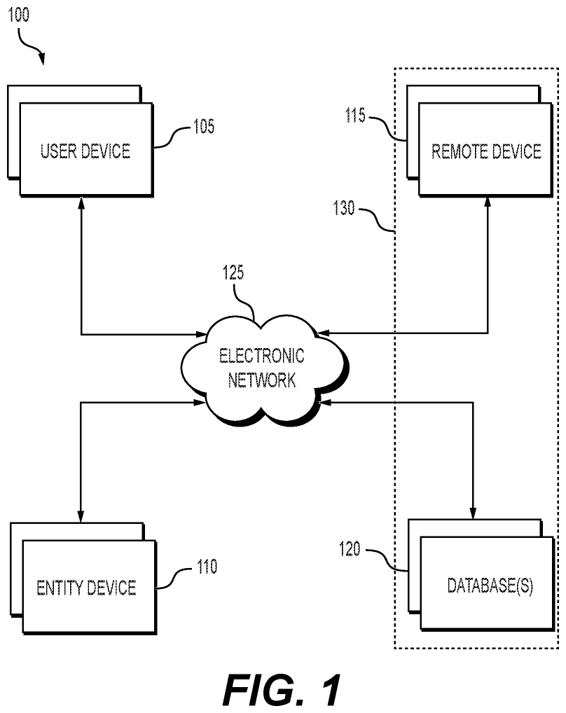

FIG. 1 depicts an exemplary environment 100 that may be utilized with techniques presented herein. One or more user device(s) 105, one or more entity device(s) 110, and one or more remote device(s) 115 may communicate with one another in any arrangement, across an electronic network 125. The user device 105 may be associated with a user who is an employee of (or contractor for) a company or business, or the like. In some embodiments, the company may be associated with (e.g., own, rent, or control) the remote device 115, a database 120, and/or the user device 105.

The user device 105 may be configured to enable the user to access and/or interact with other systems (e.g., the remote device 115, the entity device 110, and/or the database 120) in the environment 100. For example, the user device 105 may be a computer system such as a desktop computer, a laptop, a workstation, a mobile device, a tablet, etc. In some embodiments, the user device 105 may include one or more electronic application(s), such as a program, a plugin, or a browser extension, installed on a memory of the user device 105. Further, in some embodiments, the user device 105 may be configured to access one or more electronic applications, such as a program, a plugin, or a browser extension, via a cloud platform, using the electronic network 125. In some aspects, the user of the user device 105 may conduct one or more transactions (e.g., purchases of good(s) and/or service(s) on behalf of the user's company) with an entity (e.g., a merchant) associated with the entity device 110, using the electronic network 125. In some embodiments, the user device 105 may be configured to perform methods described in this disclosure.

The entity device 110 may be configured to enable an entity (e.g., a merchant) associated with the entity device 110 to interact with other systems, such as the user device 105, the remote device 115, and/or the database 120, in the environment 100. For example, the entity device 110 may be a computer system such as a server, workstation, desktop computer, a laptop, a mobile device, a tablet, etc. In some embodiments, the entity device 110 may provide a platform (e.g., a website, portal, etc.) that is associated with the entity, and with which the user of the user device 105 may interact via the electronic network 125. In some aspects, the entity may use the platform of the entity device 110 to engage in (or perform) one or more transactions (e.g., sales of good(s) and/or service(s)) with the user of the user device 105, using the electronic network 125.

The remote device 115 may be a computer system such as a server, workstation, a desktop computer, a laptop, a mobile device, a tablet, etc. In some examples, the remote device 115 may be associated with (or include) a cloud computing platform with scalable resources for computation and/or data storage. The remote device 115 may run one or more applications locally and/or using the cloud computing platform, to perform various computer-implemented methods described in this disclosure. In some embodiments, the remote device 115 may be associated with (e.g., owned, rented, or controlled by) the company that employs the user of the user device 105. Further, in an example, the remote device 115 may be accessible by and/or in communication with an accounting team of the company. In some aspects, the remote device 115 may be associated with, and/or store, a ledger of the company. The remote device 115 may also store one or more credit card statements received from an issuer of the user's credit card. Further, in some embodiments, such as embodiments in which the remote device 115 is associated with the issuer of the user's credit card, the remote device 115 may store one or more settlement requests received from the entity associated with the entity device 110.

The database 120 may include computer-readable memory such as a hard drive, flash drive, disk, etc. In some embodiments, the database 120 may include and/or interact with an application programming interface for receiving and/or transmitting data with other systems (e.g., the remote device 115, the user device 105, and/or the entity device 110) of the environment 100. Further, in some embodiments, the database 120 may be associated with (e.g., included in) the remote device 115, as denoted by the dashed box 130 in FIG. 1. The database 120 may include and/or act as a repository for interaction data received from the user device 105, via the remote device 115. For example, the database 120 may store data related to the user's interaction(s) with a website or portal (presented on a display screen of the user device 105) to conduct a transaction, as discussed in more detail below. In some embodiments, the database 120 may store one or more credit card statements (e.g., corporate credit card statements) received from a credit card issuer associated with the user. Further, in some embodiments, the database 120 may store one or more settlement requests received from the entity associated with the entity device 110. Additionally, in some embodiments, the database 120 may store a ledger for the company associated with the remote device 115.

In various embodiments, the electronic network 125 may be a wide area network (“WAN”), a local area network (“LAN”), personal area network (“PAN”), or the like. In some embodiments, electronic network 125 includes the Internet, and supports the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. For example, the database 120 may be integrated into the remote device 115, as discussed above. In another example, the user device 105 may be integrated in the remote device 115. In some embodiments, operations or aspects of one or more of the components discussed above may be distributed amongst one or more other components. Any suitable arrangement and/or integration of the various systems and devices of the environment 100 may be used.

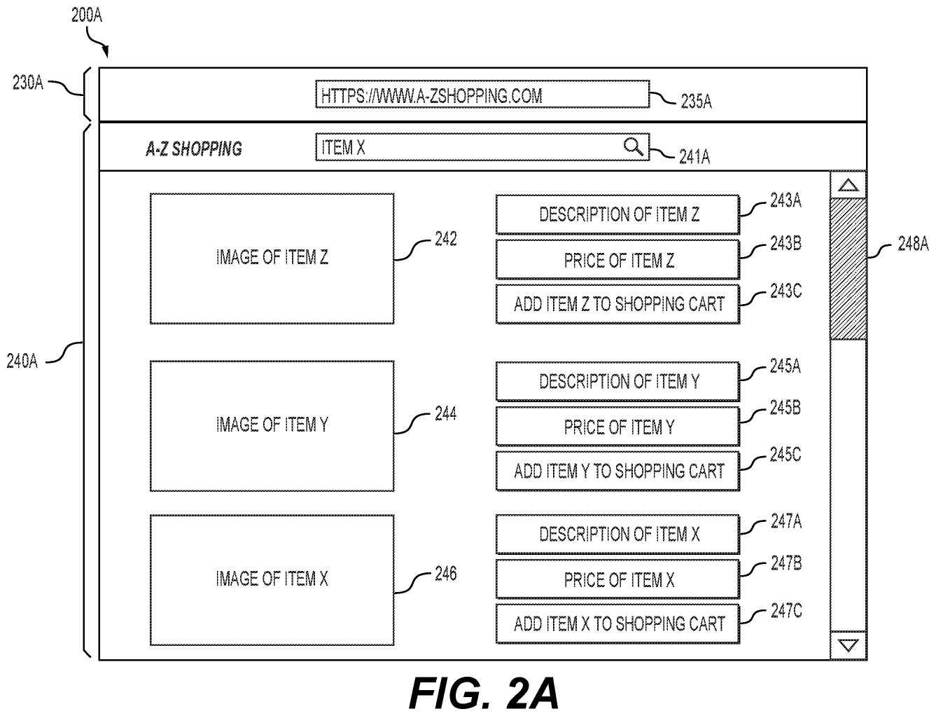

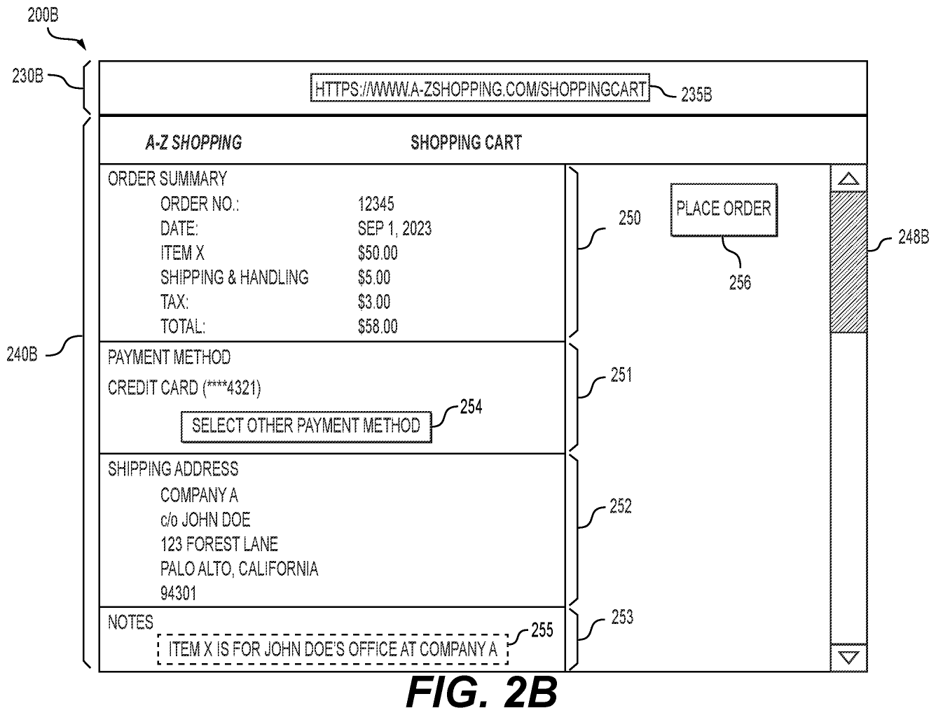

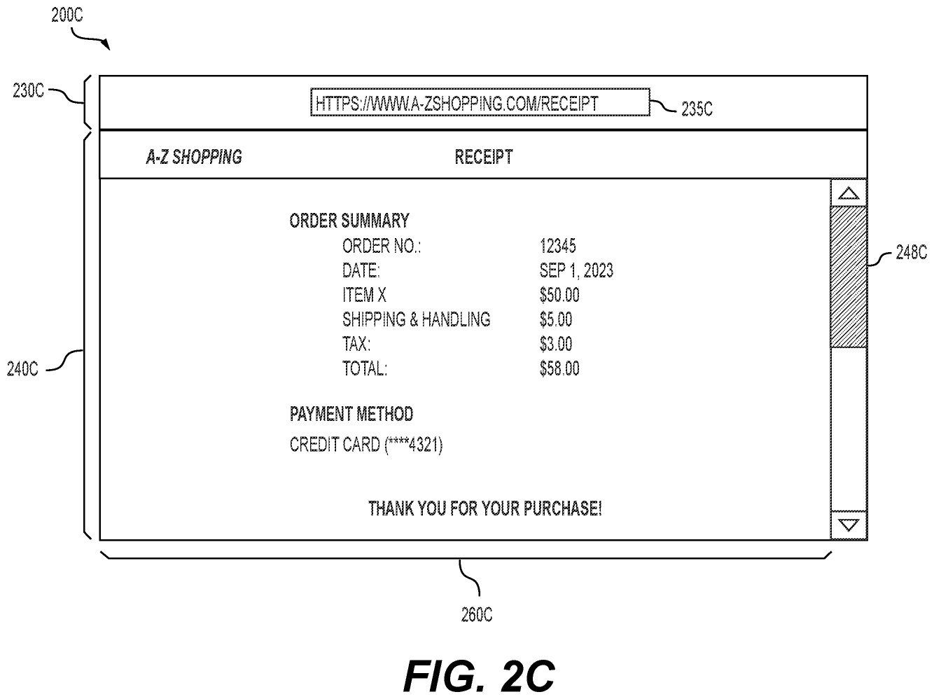

FIG. 2A depicts an example user interface 200A (also referred to herein as a “browser window 200A”) that may be displayed on the display screen of a user device (e.g., the user device 105 of FIG. 1), according to one or more embodiments. In some embodiments, a user (e.g., a person named “John Doe”) may view the browser window 200A on the user device 105 when shopping online for an item (e.g., an item X), which the user desires to purchase on behalf of the user's employer or company (e.g., Company A). As shown in FIG. 2A, the browser window 200A includes regions 230A and 240A, each of which includes (or is associated with) at least one interaction element. In some aspects, an interaction element may be one or more of a field, a text box, a button, a link, a hover state, a graphic (or an image), an animation, text, a virtual assistant, a receiver or sensor (e.g., communicatively coupled to the browser window 200A) for capturing visual or audio data, a scroll bar, or other feature(s) associated with a browser or webpage with which a user may engage or interact. An interaction element may be associated with interaction data, which is data that describes, represents, or is related to an interaction element. For example, data representing one or more of a field, data entered in the field, a text box, data entered in the text box, a button, a link, a hover state, a graphic (or image), an animation, text, a virtual assistant, a cursor that is hovering over an interaction element, an interaction element that has been selected or toggled, received image or audio data, or the position of a scroll bar, may be interaction data. As another example, a screen-shot of (or data representing) a portion or all of a browser window or webpage may be interaction data.

As shown in FIG. 2A, the region 230A includes an address bar (or field) 235A, which may be an interactive element. More specifically, FIG. 2A shows that the user may enter a web address (e.g., https://www.A-ZShopping.com) in the address bar 235A to visit the website (or web application) of a company (e.g., a company called “A-Z Shopping”), which the user believes may sell the item X. After entering the web address, https://www.A-ZShopping.com, in the address bar 235A, the user's browser may display the website (or web application) of A-Z shopping, as shown in region 240A. In some embodiments, the region 240A may include a scroll bar 248A and/or the search field 241A, each of which may be an interactive element. In some aspects, the user may enter the name of the item the user wishes to purchase (e.g., the item X) in the search field 241A to quickly search the contents of A-Z Shopping's website and determine whether the item X may be purchased on the website.

After performing the search, A-Z Shopping's website may display a list of search results. For example, as shown in the region 240A, the search results may include information and interaction elements for each of items Z, Y, and X. More specifically, the search results may include an image of the item Z 242, a description of the item Z 243A, a price of the item Z 243B, and an Add Item Z to Shopping Cart button 243C. The search results may also include an image of the item Y 244, a description of the item Y 245A, a price of the item Y 245B, and an Add Item Y to Shopping Cart button 245C. Further, the search results may include an image of the item X 246, a description of the item X 247A, a price of the item X 247B, and an Add Item X to Shopping Cart button 247C. The search results may further include information (and interaction elements) regarding other products available for purchase on A-Z Shopping's website, which the user may view by repositioning the scroll bar 248A, for example.

In some embodiments, when the user interacts with the interaction elements of regions 230A and 240A, interaction data representing the user's interactions may be extracted using an electronic application. That is, the interaction data may be scraped (e.g., by accessing content or data associated with the user interface 200A, such as a Document Object Model (DOM) of the website at https://www.A-ZShopping.com) or recorded (e.g., in a screen-shot) using, for example, a browser extension or plugin associated with the user's browser, an electronic application associated with (e.g., included in) a virtual assistant, or other computer program running on the user device (locally and/or via a cloud platform). In some embodiments, after the user reviews the image of the item X 246, the description of the item X 247A, and the price of the item X 247B, the user may wish to proceed with purchasing the item X from the website by clicking (or tapping) the Add Item X to Shopping Cart button 247C. In doing so, interaction data regarding the image of the item X 246, the description of the item X 247A, the price of the item X 247B, and/or the user's click (or tap) of the Add Item X to Shopping Cart button 247C, may be extracted by the electronic application. It should be understood that these particular examples of extracted data are illustrative only, and that in various embodiments, any suitable interaction data may be extracted.

In response to clicking (or tapping) the Add Item X to Shopping Cart button 247C, an example user interface 200B (also referred to herein as a “browser window 200B”) of FIG. 2B may be displayed on the display screen of the user device 105. As shown in FIG. 2B, the browser window 200B includes the regions 230B and 240B, which may be embodiments of the regions 230A and 240A, respectively of FIG. 2A. In some aspects, the region 230B may include an address bar (or field) 235B (an interactive element), which includes the web address, https://www.A-ZShopping.com/ShoppingCart, of a shopping cart page of A-Z Shopping's website. The region 240B includes sub-regions 250-253, a Place Order button 256, and a scroll bar 248B. In some embodiments, the sub-region 250 may include an order summary, which may specify the following information about the user's order of the item X: an order no. of 12345; a date of Sep. 1, 2023; the price of the item X, which is $50.00; a shipping and handling fee of $5.00; a tax of $3.00; and a total price for the order of $58.00. The sub-region 251 may include an indication of a payment method that the user wishes to use to complete the order of the item X. For example, the sub-region 251 may indicate that the user wishes to use a corporate credit card, of which the last four digits are 4321, to make the purchase. In some embodiments, the user's corporate credit card number (or personal credit card number) may be automatically populated in a field of the sub-region 251. The sub-region 251 may also include a Select other Payment Method button 254, which the user may select if the user wishes to enter information for a new or different payment method. The sub-region 252 may include the address to which the user wishes the item X be shipped. For example, the sub-region 252 may indicate that the item X should be shipped to Company A, c/o John Doe, at 123 Forest Lane, Palo Alto, CA 94301. In some embodiments, the sub-region 253 may include a notes field 255, in which the user may enter notes that may help the accounting team of the user's company (e.g., Company A) categorize (or code) the user's purchase. The user may indicate in the notes field 255, for example, that the item X is for John Doe's office at (or for a particular department of) Company A. In some embodiments, once the user has reviewed and verified the accuracy of the information in sub-regions 250-253, the user may click (or tap) the Place Order button 256 to complete the purchase of the item X. In doing so, interaction data relating to interaction elements associated with the browser window 200B (e.g., the text in sub-regions 250-252, the text entered in the notes field 255, and the user's click (or tap) of the Place Order button 256) may be extracted by the electronic application.

In response to clicking (or tapping) the Place Order button 256, an example user interface 200C (also referred to herein as a “browser window 200C”) of FIG. 2C may be displayed on the display screen of the user device 105. As shown in FIG. 2C, the browser window 200C includes regions 230C and 240C, which may be embodiments of the regions 230B and 240B, respectively of FIG. 2B. In some aspects, the region 230C may include an address bar (or field) 235C (an interactive element), which includes the web address, https://www.A-ZShopping.com/Receipt, of a receipt page of A-Z Shopping's website. The region 240C includes a sub-region 260C and a scroll bar 248C. As shown in FIG. 2C, the sub-region 260C may include a receipt for (or summary of) the user's completed purchase of the item X. That is, the sub-region 260C may include an order summary that specifies the following information: the order no. of 12345; the date of Sep. 1, 2023; the price of the item X, which is $50.00; the shipping and handling fee of $5.00; the tax of $3.00; and the total price for the order of $58.00. The sub-region 260C may also include a statement such as “Thank you for your purchase!” In some embodiments, where the browser window 200B of FIG. 2B does not include the notes field 255, the sub-region 260C of FIG. 2C may include a notes field in which the user may enter a description of the purchase to assist the accounting team of Company A with categorizing (or coding) the purchase. Further, in some aspects, interaction data relating to interaction elements in the browser window 200C (e.g., the text in the region 240C) may be extracted by the electronic application. It should be understood that the user interfaces (or browser windows) 200A-200C and the interaction elements associated therewith are merely examples. The techniques and technologies of this disclosure may be adapted to any suitable user interface.

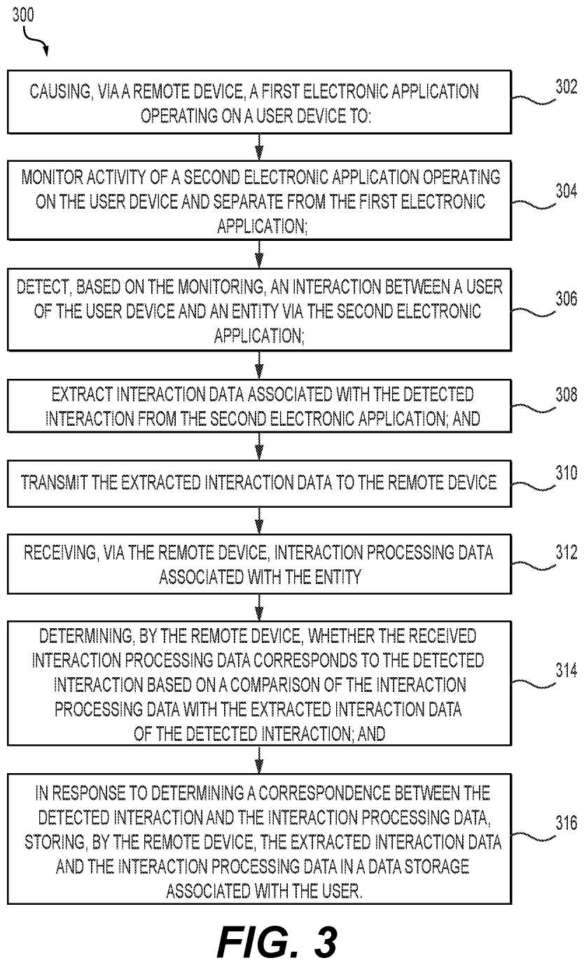

FIG. 3 is a flowchart illustrating a method 300 for recordation of interaction data, according to one or more embodiments of the present disclosure. In some aspects, the interaction data may be an embodiment of the interaction data (e.g., one or more of a field, a button, a graphic, etc.) discussed above with reference to FIGS. 2A-2C. The method 300 may be performed by the remote device 115 or the user device 105. In some embodiments, the method 300 may be performed when a user (e.g., John Doe) of the user device 105 shops online for an item (e.g., the item X), which the user wishes to purchase on behalf of the user's employer or company (e.g., the Company A). The company may be associated with (e.g., own, rent, or control) the remote device 115. While shopping, the user may view, for example, the browser window 200A or another user interface, on a display screen of the user device 105.

As shown in FIG. 3, the method 300 may include causing, via the remote device 115, a first electronic application operating on the user device 105 to perform various operations (step 302). The first electronic application may be, for example, a browser extension, a plugin, or a computer program associated with a virtual assistant or virtual assistant chat bot, or other computer program, running on the user device 105 locally and/or via a cloud platform.

In some embodiments, the first electronic application may be caused, via the remote device 115, to monitor activity of a second electronic application operating on the user device 105 and separate from the first electronic application (step 304). The second electronic application may be, for example, a browser, a website or web application (e.g., the web application of A-Z Shopping, as discussed above with references to FIGS. 2A-2C), or other computer program. In some embodiments, the first electronic application may monitor the second electronic application by, for example, determining when the second electronic application is running, locally and/or via a cloud platform, on the user device 105. Further, in some embodiments, the method 300 may include causing the first electronic application to inject predetermined interaction data into the second electronic application. For example, the first electronic application may inject the user's identity, shipping address, and/or credit card number into corresponding fields of the second electronic application.

In some embodiments, the first electronic application may modify the second electronic application, e.g., in order to impose one or more limitations on an interaction between the user and the second electronic application. In an example, the first electronic application may inject the user's corporate credit card number into a corresponding field of the second electronic application; and/or disable other payment methods (e.g., by disabling the Select other Payment Method button 254 of FIG. 2B) supported by the second electronic application. In doing so, the first electronic application requires the user to use their corporate credit card for purchases made using the second electronic application. As yet another example, the first electronic application may inject a notes field (e.g., the notes field 255 of FIG. 2B) into a user interface of the second electronic application.

In some embodiments, the first electronic application may be caused, via the remote device 115, to detect, based on the monitoring of step 304, an interaction between a user of the user device 105 and an entity (e.g., A-Z Shopping) via the second electronic application (step 306). The detecting may be based on, for example, one or more of a website address of a website (e.g., https://www.A-ZShopping.com) visited by the user via the second electronic application, content of the website, an interaction or pattern of interactions of the user with the website via the second electronic application, or entry of data associated with a predetermined interaction element by the user into the website via the second electronic application. As used herein, a “pattern” of interactions generally encompasses multiple interactions that, when conducted near each other in time, may be indicative or correspond to a past, in-progress, or future purchase of an item. A pattern may be predetermined via manual entry, learned, e.g., via aid of one or more machine-learning techniques, or determined via any suitable technique. In some embodiments, a particular pattern may correspond to a particular entity, a particular website, a particular category of items, or the like. The predetermined interaction element may be a field or other element in which the user may enter or specify data to make a purchase (for example, of the item X) using the website and the second electronic application. Further, in some embodiments, the method 300 may include causing the user device 105 to limit the detected interaction with regard to one or more of at least one predetermined website, at least one predetermined item, or at least one predetermined interaction element. For example, the user device 105 may limit the detected interaction to an interaction associated with (or involving) one or more of a whitelisted website, a particular category of item, a transaction amount, a time of day, etc. In some embodiments, where the second electronic application is a whitelisted (or predetermined) website and where the first electronic application is a browser extension, for example, the method 300 may include causing, via the remote device 115, the browser extension operating on the user device 105 (step 302) to monitor activity of the whitelisted website operating on the user device 105 and separate from the browser extension (step 304); and detect, based on the monitoring, an interaction between the user of the user device 105 and an entity via the whitelisted website (step 306).

In an exemplary use case, an employee may, from time to time, make purchases on behalf of their employer using a device they also use to make personal purchases. The first electronic application may, for example, distinguish between such purchases, e.g., in order to maintain the employee's privacy and not harvest data when they are making personal purchases. For instance, a purchase made during working hours, at a location associated with the employer, for a category of items associated with the employee's job, using a corporate card vs. a personal card, etc., may indicate a likelihood that the purchase is on behalf of the employer rather than personal. In some embodiments, an employee's history of purchases made on behalf of the employer may be stored and compared with a current purchase to help distinguish whether the purchase is personal or on behalf of the employer. For instance, if the employee has a history of buying office supplies, a current purchase for office supplies may be more likely to be on behalf of the employer. Any suitable technique for distinguishing between purchase types based on criteria such as the above may be used (e.g., a scoring algorithm, decision tree, a machine learning technique, etc.). In some embodiments, if the first electronic application determines that it is likely a purchase is on behalf of an employer or the like, the first electronic application may recommend or force adjustments to the interaction, e.g., recommending or forcing use of a corporate card as discussed above, recommending or forcing a delivery address associated with the employer, etc.

In some embodiments, the first electronic application may be caused, via the remote device 115, to extract interaction data associated with the detected interaction from the second electronic application (step 308). In some aspects, the extracting of the interaction data may be performed in a background context that is opaque to the user of the user device 105. In some embodiments, the extracting of the interaction data may include capturing a screen-shot of the second electronic application (e.g., a screen-shot of the browser window 200A, 200B, or 200C of FIGS. 2A-2C, respectively). In some embodiments, the extraction of the interaction data may include accessing data stored by the second electronic application. Further, the extracting of the interaction data may include automatically downloading a receipt from a website (e.g., A-Z Shopping's website). In some embodiments, the extracting of the interaction data may be performed prior to, during, and/or after the detected interaction being completed. For example, before the user clicks (or taps or selects) the Place Order button 256 in the browser window 200B (of FIG. 2B) to purchase the item X, interaction data representing part or all of the browser window 200B (and/or the browser window 200A) may be scraped by the first electronic application. In another example, after the user selects the Place Order button 256 in the browser window 200B, data from the browser window 200C may be extracted.

The first electronic application may further be caused, via the remote device 115, to transmit the extracted interaction data to the remote device 115 (step 310). In some embodiments, either before or after the transmission of step 310, the first electronic application may prompt the user to enter additional interaction data (e.g., in the notes field 255 of FIG. 2B) associated with the detected interaction. Further, the method 300 may include receiving, at the remote device 115 and from the user device 105, the additional interaction data. The method 300 may further include appending (or associating) the additional interaction data to the extracted interaction data.

In some embodiments, the method 300 may include receiving, via the remote device 115, interaction processing data associated with the entity (e.g., A-Z Shopping) (step 312). The interaction processing data may include, for example, a credit card statement and/or a settlement request that relates to (or describes) one or more transactions involving the user (e.g., John Doe) and/or the entity (e.g., A-Z Shopping). More specifically, the interaction processing data may include information such as a user identifier (e.g., the name “John Doe,” or another identifier of the user), an account number, an identification number, date and/or amount of a purchase (or transaction), part or all of a credit card number (e.g., a corporate credit card number or personal credit card number), an identifier of the entity (e.g., the name, “A-Z Shopping,” a merchant category code (MCC)), or other information associated with a purchase made by the user on behalf of the user's company, from the entity.

The method 300 may also include determining, by the remote device 115, whether the received interaction processing data corresponds to the detected interaction based on a comparison of the interaction processing data with the extracted interaction data of the detected interaction (step 314). For example, the remote device 115 may determine whether one or more pieces of information (e.g., an amount of a transaction and an entity involved in the transaction) included in the received interaction processing data matches or corresponds to one or more pieces of information (e.g., an amount of a transaction and an entity involved in the transaction) included in the extracted interaction data.

The method 300 may include, in response to determining a correspondence between the detected interaction and the interaction processing data, storing, by the remote device 115, the extracted interaction data and the interaction processing data in a data storage associated with the user (step 316). For example, the extracted interaction data and the interaction processing data may be stored in one or more regions of the database 120 that are associated with the user. Further, in some embodiments, the method 300 may include, in response to determining the correspondence, causing the first electronic application to output a notification indicative of the correspondence to, for example, the user on the user device 105.

In some aspects, the method 300 may further include receiving, via a user interface operatively connected with the remote device 115, a request for data associated with the user. The request for data may be prepared or initiated by the accounting team of the user's company, for example. The method 300 may include, in response to receiving the request, causing the user interface to output the extracted interaction data and the interaction processing data in a standardized format. In some embodiments, the accounting team may use the output to categorize (or code) one or more of the user's purchases (e.g., the user's purchase of the item X) described by the extracted interaction data and the interaction processing data. The accounting team may then include the one or more categorized (or coded) purchases in the company's ledger. Accordingly, the method 300 provides an automated and streamlined process for detecting and verifying receipts (and other transaction data) for purchases made online by the user on behalf of the user's company, so that the company's accounting team may review, categorize, and record the purchases in the company's ledger. Moreover, the method 300 helps to ensure that the company's ledger is accurate, complete, and updated in a timely manner.

In general, any process or operation discussed in this disclosure that is understood to be computer-implementable, such as the process illustrated in FIG. 3, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

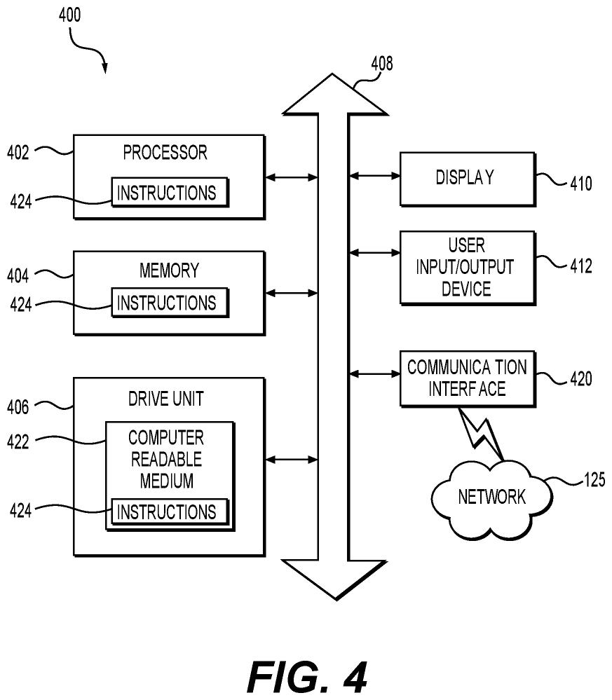

FIG. 4 is a simplified functional block diagram of a computer 400 that may be configured as a device for executing the method of FIG. 3, according to exemplary embodiments of the present disclosure. For example, the computer 400 may be configured as the remote device 115 or the user device 105, according to exemplary embodiments of this disclosure. In some embodiments, the computer 400 may be configured as the entity device 110, according to exemplary embodiments of this disclosure. In various embodiments, any of the devices or systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display (or display screen) 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for recordation of interaction data, comprising:
causing, via a remote device, a first electronic application operating on a user device to:
monitor activity of a second electronic application operating on the user device and separate from the first electronic application;
detect, based on the monitoring, an interaction between a user of the user device and an entity via the second electronic application;
extract interaction data associated with the detected interaction from the second electronic application; and
transmit the extracted interaction data to the remote device;
receiving, via the remote device, interaction processing data associated with the entity;
determining, by the remote device, whether the received interaction processing data corresponds to the detected interaction based on a comparison of the interaction processing data with the extracted interaction data of the detected interaction; and
in response to determining a correspondence between the detected interaction and the interaction processing data, storing, by the remote device, the extracted interaction data and the interaction processing data in a data storage associated with the user.

2. The computer-implemented method of claim 1, further comprising:
receiving, via a user interface operatively connected with the remote device, a request for data associated with the user; and
in response to receiving the request, causing the user interface to output the extracted interaction data and the interaction processing data in a standardized format.

3. The computer-implemented method of claim 2, further comprising:
in response to determining the correspondence, causing the first electronic application to output a notification indicative of the correspondence.

4. The computer-implemented method of claim 1, further comprising:
causing the first electronic application to prompt the user to enter additional interaction data associated with the detected interaction;
receiving, at the remote device and from the user device, the additional interaction data; and
appending the additional interaction data to the extracted interaction data.

5. The computer-implemented method of claim 1, wherein detecting the interaction is based on one or more of a website address of a website visited by the user via the second electronic application, content of the website, an interaction or pattern of interactions of the user with the website via the second electronic application, or entry of data associated with a predetermined interaction element by the user into the website via the second electronic application.

6. The computer-implemented method of claim 1, further comprising:
causing the user device to limit the detected interaction with regard to one or more of at least one predetermined website, at least one predetermined item, or at least one predetermined interaction element.

7. The computer-implemented method of claim 1, further comprising:
causing the first electronic application to inject predetermined interaction data into the second electronic application.

8. The computer-implemented method of claim 1, wherein the extracting of the interaction data is performed in a background context that is opaque to the user of the user device.

9. The computer-implemented method of claim 1, wherein the extracting of the interaction data includes capturing a screen-shot of the second electronic application.

10. The computer-implemented method of claim 1, wherein the extracting of the interaction data is performed prior to the detected interaction being completed.

11. A computer-implemented method for recordation of interaction data, comprising:
causing a first electronic application operating on a user device to:
monitor activity of a second electronic application operating on the user device and separate from the first electronic application;
detect, based on the monitoring, an interaction between a user of the user device and an entity via the second electronic application;
extract interaction data associated with the detected interaction from the second electronic application; and
transmit the extracted interaction data to a device remote from the user device.

12. The computer-implemented method of claim 11 wherein:
the extracting of the interaction data is performed in a background context that is opaque to the user of the user device; and
the method further comprises:
receiving, via the remote device, interaction processing data associated with the entity;
determining, by the remote device, whether the received interaction processing data corresponds to the detected interaction based on a comparison of the interaction processing data with the extracted interaction data of the detected interaction; and
in response to determining a correspondence between the detected interaction and the interaction processing data, storing, by the remote device, the extracted interaction data and the interaction processing data in a data storage associated with the user.

13. The computer-implemented method of claim 12, further comprising:
receiving, via a user interface operatively connected with the remote device, a request for data associated with the user; and
in response to receiving the request, causing the user interface to output the extracted interaction data and the interaction processing data in a standardized format.

14. The computer-implemented method of claim 13, further comprising:
in response to determining the correspondence, causing the first electronic application to output a notification indicative of the correspondence.

15. The computer-implemented method of claim 11, further comprising:
causing the first electronic application to prompt the user to enter additional interaction data associated with the detected interaction;
receiving, at the remote device and from the user device, the additional interaction data; and
appending the additional interaction data to the extracted interaction data.

16. The computer-implemented method of claim 11, wherein detecting the interaction is based on one or more of a website address of a website visited by the user via the second electronic application, content of the website, an interaction or pattern of interactions of the user with the website via the second electronic application, or entry of data associated with a predetermined interaction element by the user into the website via the second electronic application.

17. The computer-implemented method of claim 11, further comprising:
causing the user device to limit the detected interaction with regard to one or more of at least one predetermined website, at least one predetermined item, or at least one predetermined interaction element.

18. The computer-implemented method of claim 11, further comprising:
causing the first electronic application to inject predetermined interaction data into the second electronic application.

19. The computer-implemented method of claim 11, wherein:
the extracting of the interaction data includes capturing a screen-shot of the second electronic application; and
the extracting of the interaction data is performed prior to the detected interaction being completed.

20. A non-transitory computer-readable medium comprising instructions for recordation of interaction data, the instructions executable by at least one processor of a remote device to perform operations, including:
causing a first electronic application operating on a user device to:
monitor activity of a second electronic application operating on the user device and separate from the first electronic application;
detect, based on the monitoring, an interaction between a user of the user device and an entity via the second electronic application;
extract interaction data associated with the detected interaction from the second electronic application; and
transmit the extracted interaction data to the remote device;
receiving interaction processing data associated with the entity;
determining whether the received interaction processing data corresponds to the detected interaction based on a comparison of the interaction processing data with the extracted interaction data of the detected interaction; and
in response to determining a correspondence between the detected interaction and the interaction processing data, storing the extracted interaction data and the interaction processing data in a data storage associated with the user.
